(19) United States
(12) Patent Application Publication
(10) Pub. No.: US 2002/0156617 A1
(43) Pub. Date: Oct. 24, 2002

(54) Electonic speaking dictionary: a simple device for finding, pronounincing, and defining a word

(76) Inventor: Jon Andrew Aretakis, Vista, CA (US)

Correspondence Address: Jon Aretakis, 2505 Green Meadow Way, Vista, CA, 92083, US

(21) Appl. No.: 10/102,342

(22) Filed: Mar. 21, 2002

Related U.S. Application Data
(60) Provisional application No. 60/285,411, filed on Apr. 20, 2001.

(51) Int. Cl. G06F 17/28

(52) U.S. Cl. 704/7

(57) ABSTRACT

A device for finding a word even when the user knows a limited number of letters. In the device a keyboard is incorporated to enable the user to type in any numbers of letters in order for the device to find the requested word. By entering the first three letters of the word into the device, the device will draw from it internal memory a selection of words similar to the requested word fraction. The device will display the words from the memory in a scroll form on a display screen.

The user will scroll down, when he/she recognizes the requested word, the user will command “Enter” by pressing the enter button. The list of scroll word will then disappear and the word selected along with the definition will appear on the screen. The user will then press the “Speak” key. The word will then be pronounced. The simplicity of using fore mentioned device along with its embodiment sets it apart from all others.

This application claims the benefit of filing date, JC973 U.S. P.T.O No. 60/285,411, filed on Apr. 20, 2001.

Cross References cited:

U.S. Pat. Nos. 4,490,811 4,830,618 5,113,340 5,396,606

### BACKGROUND OF INVENTION

1. Field of Invention

The present invention relates to a device and method for finding a requested word. More particularly, the invention relates to a method for displaying similar words, such as, alphabetically close to the requested word in order for the user to identify “His/Her” word and then to listen to the pronunciation of the word as well as reading the definition of the word.

2. Description of Related Art

Talking dictionaries have become well known in the past few years. These devices incorporate many more functions besides a speaking Dictionary that make the machines complicated and arduous to use. In light of the foregoing, a need exist for an electronic device using a system and a method as simple as the user would “Fast page” through a dictionary to find “His/Her” word, with the added advantage of having the device sound the word out. This invention encompasses the mere necessities of a speaking dictionary. Twenty-six alphabetic keys an “Enter key”, and a “Speak key”, an “Off/On button”, and two scroll buttons located on one side and a volume control on the other side, of the device, will comprise the keyboard. I claim to have created an invention of a much simpler means to locate, spell check, and hear any given word, and it will be available to the consumer at a cheaper cost than other Speaking Dictionaries. I believe the simplicity of this device sets it apart from any other. It is a hand held speaking dictionary that does nothing more than locate, spell check and pronounce a given word. Furthermore, other hand held speaking dictionaries on the market today utilizes a keyboard type lay of the alphabetic keys. This is a disadvantage to the average user because most people don't know how to type. I have designed a keypad that reads right from left with the letter “A” beginning in the top left corner. This lay out allows for easy access to the letters on the keypad, making it easier for the user to find the necessary letters to spell any given word. The simplicity promotes easy use for a fraction of the cost as compared to other speaking dictionaries on the market today.

### BRIEF DESCRIPTION OF THE DRAWING

1) LCD Panel

2) Audio Speaker

3) Alphabetic keys

4) Speak key

5) Enter key

6) Headphone connecter

7) Volume control

8) Scroll Buttons

9) Plastic casing

10) Battery department

FIG. 1. is a block diagram of exemplary electronic components located within the device in accordance with the present invention.

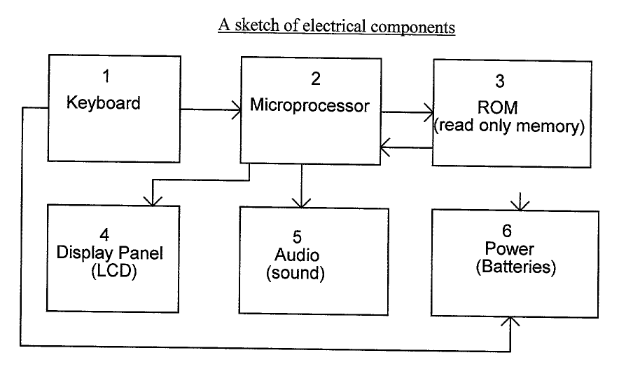

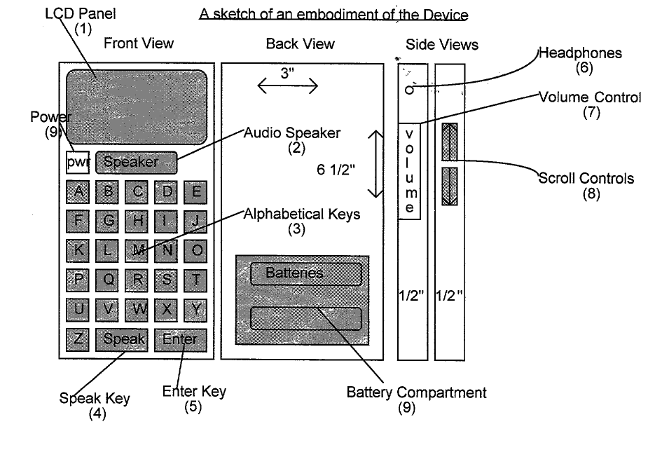

[image]

### DETAILED DESCRIPTION OF INVENTION

In accordance with the present invention, a device and method are provided for searching and finding a requested word, even when only the user knows a fraction of the word. The device comprises a keyboard (1) with alphabetical keys, an on/off key, an enter key, and up/down scroll keys. A Microprocessor (2), a ROM {Read only memory}, (3) a display screen {LCD}(4), an Audio system (5) consisting of an electronic speech generator chip, which sounds the word when commanded to do so. The sound is emitted through a built-in-speaker. A headphone connector is within the device, as well as a volume control, and a power supply, Batteries. (6) With the device switched on at the keyboard (1), power is supplied to the electronic components of the device. A fraction of the word (at least the first three letters, or the word in it entirety is entered into the keyboard. The Microprocessor (2) commands the read only memory (3) to search alphabetically close words in it memory and then passes this information back to the Microprocessor. The Microprocessor displays this information in pixel form onto the LCD. The user then scrolls up and down the list of displayed words until he/she finds the desired word, and then hits enter. This will bring up the isolated word and its simple definition. The user then pushes the speak key (The microprocessor will then command the audio electronics (5) to sound out the word. Additional words are selected by repeating the above process.

This invention relates to the display and acoustical sounding of the description of the definition of words selected by person using device manufactured according to the electrical and mechanical principals described in this invention:

What I claim is:

1. A, simple to use, speaking dictionary and spell check device, comprising:
I) A device that pronounces a given word when that word or part there of has been entered into said device.
II) A device, which incorporates a visual display of information as well as audible information requested by the user of said device.
III) A device according to claim one, which incorporates a keyboard with all the letters of the alphabet of a particular language for which the device is manufactured.
IV) A device according to claims one and two, which uses batteries as a power supply.
V) A device according to claim three which uses a solar cell should the battery is of the rechargable kind.
VI) A device according to claims one, two, three, and four, which is supplied with a volume control and a scroll control of the information requested by the user.
VII) A device according to claim five, which has additional selections on the keyboard for sound and display.
VIII) A device for which one of its design examples, functions to the accompany block diagram and sketch of the embodiment of the device for which I request a patent to be granted.
VIIII) I claim the embodiment of the device, as shown in drawing.
The claims made above should by no means be construed as a limitation of the ingenuity of the inventor as to variations and enhancement of the invention.
